(19) United States
(12) Patent Application Publication
(10) Pub. No.: US 2021/0233007 A1
(43) Pub. Date: Jul. 29, 2021

(54) ADAPTIVE GROUPING OF WORK ITEMS

(71) Applicant: salesforce.com, inc., San Francisco, CA (US)

(72) Inventor: Robert Lacy, Burlington, MA (US)

(21) Appl. No.: 16/774,223

(22) Filed: Jan. 28, 2020

(51) Int. Cl. G06Q 10/06; G06N 20/00; G06K 9/62

(52) U.S. Cl. CPC G06Q 10/06316; G06Q 10/063118; G06K 9/6262; G06N 20/00

(57) ABSTRACT

A method of identifying a task to be completed in a task-tracking system. A first task to be completed by a user is used to identify a second task that can be completed by the user. A similarity score indicating a similarity of the second task to the first task can be used to identify the second task as being related to the first task.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Task-tracking systems are used in a variety of contexts and industries. For example, in software development common task-tracking systems include bug- and feature-tracking systems used by developers to capture bug reports and/or feature requests, each of which is then available for assignment to, or selection by, a developer. When a developer selects a task to complete, it may be flagged in the tracking system as, for example, being “checked out” to the developer so that other developers do not simultaneously attempt to address the same work item. More generally, most task-tracking systems provide a mechanism for a worker to select a task to complete and a mechanism for the worker to indicate when the task is complete. Task-tracking systems also may provide a means to “tag” or otherwise assign arbitrary identifiers to tasks. These identifiers may be helpful in enhancing productivity by enabling grouping of similar tasks. In some cases a user can filter open tasks by tag. These systems rely on users to accurately apply labels consistently and grouping may be difficult if identifiers are not easily found or repeatedly mislabeled.

### BRIEF DESCRIPTION OF THE DRAWINGS

FIG. 1 illustrates a computer system suitable for use with the disclosed subject matter.

FIG. 2 illustrates a flow chart for performing an implementation of an adaptive method for grouping work items as disclosed herein.

FIG. 3 illustrates a flow chart for performing three phases of the adaptive method illustrated in FIG. 2.

FIG. 4 illustrates a flow chart for performing a first phase of the adaptive method illustrated in FIG. 2.

FIG. 5 illustrates a flow chart for performing a second phase of the adaptive method illustrated in FIG. 2.

FIG. 6 illustrates a flow chart for performing a third phase of the adaptive method illustrated in FIG. 2.

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Task-tracking systems, such as project management software, bug- and feature-tracking systems, and the like typically allow a user of the system to “check out” or otherwise indicate a task in the system that the user intends to address. For example, a developer may mark a bug report in a bug-tracking system as one that she is currently working on, so as to prevent other developers from attempting to fix the same bug simultaneously. In some cases tasks may be assigned a priority, added to individual user worklists, or otherwise marked for action by a particular user or in a particular order relative to other tasks. Some systems also allow for tags, categories, or other identifiers to be applied to work items tracked by the system. Outside of these techniques, however, conventional systems generally do not provide any way for a user to determine which tasks should be performed before other tasks, or if there are related tasks that could be addressed together. It has been found that efficiency and accuracy of task completion may be improved if a user is notified of related work items that could be completed while the user is completing a first work item. Embodiments disclosed herein provide systems and method that allow for a task tracking system to identify and suggest related work items when a user selects or is assigned a first task for completion, thereby improving the efficiency and accuracy of the system.

Embodiments disclosed herein may provide other benefits as well. For example, if a team happens to be working on a part of a legacy system, it will already incur development, testing and regression costs and these costs are often relatively fixed. If related low-priority items can be identified, the scales can tip dramatically in favor of fixing these items concurrently. Implementations of the present system automatically suggest related items that might be useful to work on in conjunction with planned work. That is, embodiments disclosed herein may allow for automatic identification of related tasks in a task-tracking system, such as a software bug- and/or feature-tracking system, that a developer can address at the same time as a primary task selected by the user. The input for recommendations can come in various forms. For example, automatic- or human-curated inputs may include categorization and tagging of items within the system. When work items are filed, simply noting the functional area can be a huge help in recommending related work. Other inputs may include various forms of Machine Learning, such as NLP and other standard techniques, allow for work item attributes to be mined to produce similarity scores. Suggestions can then be presented to human users based on the similarity scores, and feedback can be gathered to help further train a machine learning model as disclosed in further detail here.

Other benefits may be realized as complex systems grow, in which case many smaller/lower-priority work items, such as updates, changes, additions, and the like, may drop below the threshold of value vs. effort given the complexity of the system. The benefit, e.g., changing text to comply with a document style guide, no longer outweighs the development and testing time as well as the regression risk of touching otherwise stable legacy code. But these issues may accumulate within the system and two things often happen: 1) work items are filed and ignored, growing and cluttering tracking systems over time, slowing down productivity due to backlog bloat (since it takes longer and longer to verify whether a given issue has already been added to the system); and 2) work items may not filed or addressed and the same bugs or other issues to be addressed may be discovered and triaged over and over again. Typically a combination of these issues may occur, but the end result is a small but steadily growing tax on productivity over time. Yet despite this tax, it remains more cost effective to never fix these issues than to fix them, at least in isolation. Embodiments disclosed herein may reduce or remove this additional overhead by allowing users to address and complete related tasks that are tracked by the system.

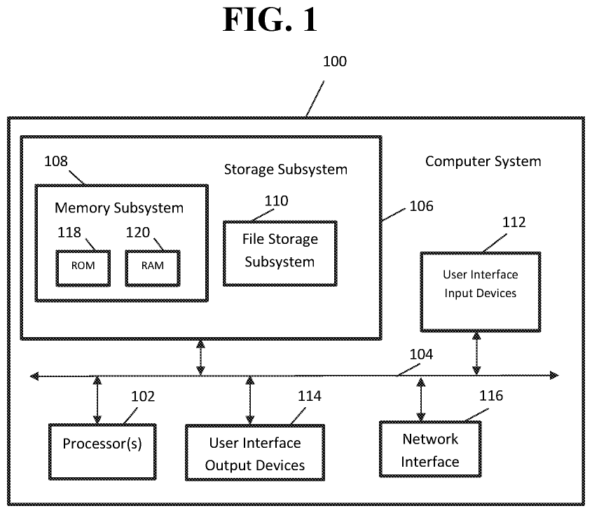

FIG. 1 is a block diagram of an example computer system 100 for grouping new and existing work items together. Computer system 100 may include at least one processor 102 that communicates with a number of peripheral devices via bus subsystem 104. These peripheral devices may include a storage subsystem 106 including, for example, memory subsystem 108 and a file storage subsystem 110, user interface input devices 112, user interface output devices 114, and a network interface subsystem 116. The input and output devices allow user interaction with computer system 100. Network interface 116 may provide an interface to outside networks, including an interface to corresponding interface devices in other computer systems.

User interface input devices 112 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 100.

User interface output devices 114 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide a non-visual display such as audio output devices. In general, use of the term “output device” is intended to include all possible types of devices and ways to output information from computer system 100 to the user or to another machine or computer system.

Storage subsystem 106 stores programming and data constructs that provide the functionality of some or all of the modules and methods described herein. These software modules are generally executed by processor 102 alone or in combination with other processors.

The memory 108 used in the storage subsystem may include a number of memories including a main random access memory (RAM) 118 for storage of instructions and data during program execution and a read only memory (ROM) 120 in which fixed instructions are stored. The file storage subsystem 110 may provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 110 in the storage subsystem 106, or in other machines accessible by the processor.

Bus subsystem 104 may provide a mechanism for letting the different components and subsystems of computer system 100 communicate with each other as intended. Although bus subsystem 104 is shown schematically as a single bus, alternative implementations of the bus subsystem may use multiple busses.

Computer system 100 may be of varying types including a workstation, server, computing cluster, blade server, server farm, or any other data processing system or computing device. Due to the ever-changing nature of computers and networks, the description of computer system 100 depicted in FIG. 1 is intended only as one example. Many other configurations of computer system 100 are possible having more or fewer components than the computer system depicted in FIG. 1.

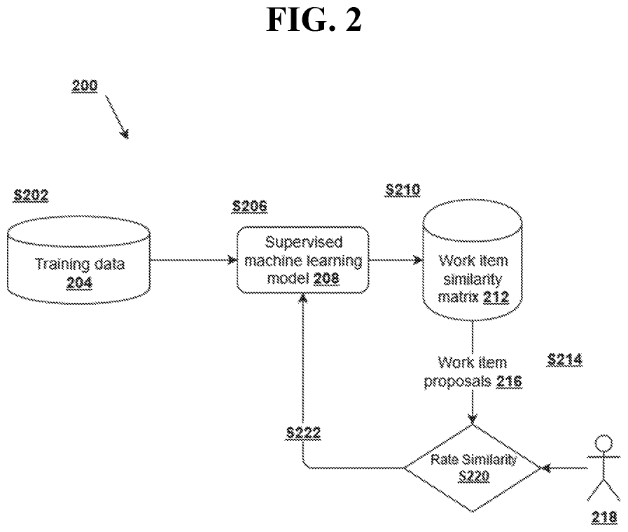

A flowchart for performing a method 200 of identifying similar work items in a task-tracking system is illustrated in FIG. 2. At step S202, training data 204 may be input into the system 100. The training data may include, for example, artificial or previously-known work items such as may be tracked by the task-tracking system and an indication of which items are related. The training data also may include similarity scores as disclosed below for the training data work items. As a specific example, a user may provide a large number (such as a few hundred to a thousand) pairs of work items that include manually-created similarity scores which are loaded into the model. The model may then be trained on these initial pairs. Such a technique typically is used for supervised machine learning approaches, though other forms of machine learning may be used without departing from the scope or content of the disclosed subject matter. At step S206, a machine learning model 208 may be created and stored in the storage subsystem 106. At step S210, at least one work similarity matrix 212 may be created and stored in a database 212a within the storage subsystem 106. At step S214, one or more work item proposals 216 may be suggested to a user 218 as suggestions to work on in conjunction with a recent work item. The input for recommendations can come in various forms, as disclosed in further detail herein. For example, automatic- or human-curated inputs may include categorization and tagging of items within the system. When work items are filed, simply noting the functional area can be a huge help in recommending related work. Other inputs may include items resulting from various forms of Machine Learning, such as NLP and other standard techniques, which allow for work item attributes to be mined to produce similarity scores. Suggestions can then be presented to human users based on the similarity scores, and feedback can be gathered to help further train a machine learning model. Such techniques are disclosed in further detail below.

At decision step S220, the user 218 may indicate whether the work item proposals 216 are a match with the recent work item, i.e., whether the user has determined to accept the proposed work item(s) to complete at the same time as the recent work item, and/or whether the proposal is an accurate work item that could reasonably be completed at the same time as the initial recent work item, regardless of whether the user decides to complete the proposed item(s) at that time or not. And at step S222, the user's input is stored may be the storage subsystem 106 and may be used by the processor 102 to update the machine learning model 208 to provide more precise future work item proposals. The method 200 will be discussed in more detail below.

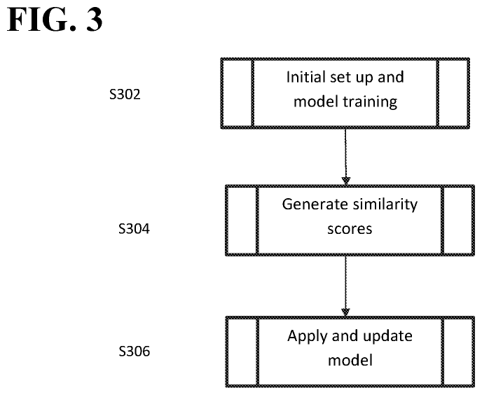

As illustrated in FIG. 3, the method 200 may include three phases of operation, or may be modeled as operating within such phases. Phase 1 is illustrated as step S302, which includes initial setup and model training. Phase 2 is illustrated as step S304, which includes generating similarity scores. Phase 3 is illustrated as step S306, which includes applying and updating the model.

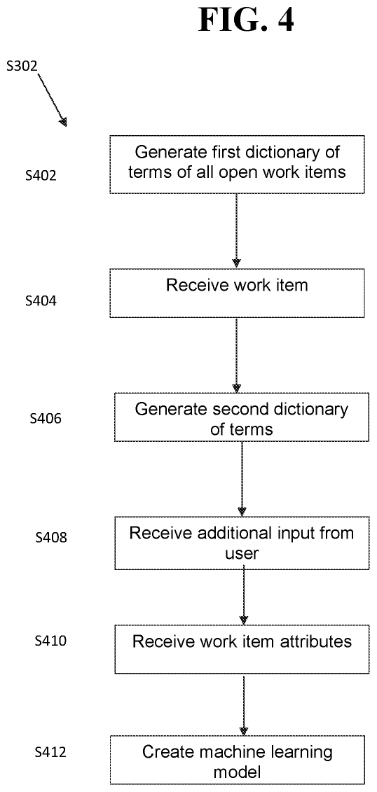

As illustrated in FIG. 4, Step S302, initial setup and machine learning model training, may include a step S402 of generating a first dictionary of terms. The first dictionary of terms may include a dictionary of terms available in relation to all open work items. For example, a first open work item, i.e., an unfinished work item, may be “Create a Chinese-to-English Translator,” and a second open work item may be “Create a Chinese language dictionary for spellcheck.” Any terms associated with both of these open work items may populate the first dictionary. “Create,” “Chinese,” “English,” “Translator” may be a first list of terms associated with the first open work item and “Chinese,” “language,” “dictionary,” “spellcheck,” etc. may be a second list of terms associated with the second open work item. Both lists of terms may populate the first dictionary. The lists of terms and their association with a particular open work item may be used by the work item similarity matrix 212 in the database 212a for use in generating a similarity score, which is discussed in further detail below.

At step S404, the system receives a work item. For example, spellcheck software being modified to include a new language capability (Chinese, German, Farsi, etc.) may need to be tested. A corresponding work item may be titled one or a combination of the following titles: “build and confirm operability of spellcheck software,” “remove problems in software,” “add Chinese language,” “add translations,” or the like. As previously disclosed, the machine learning model may be trained initially with user-provided data, including initial similarity scores, dictionary terms, work items, and the like.

The received work item may be a new work item or it may be a work item already in-progress. For example, an “in-progress” work item may be one that was created in another system but is being opened for the first time in the present system. In some implementations, an “in-progress” work item may be one that was created in the present system but has not yet been compared with existing work items to determine a similarity score. In other implementations, an “in-progress” work item may be one in which the work item has been compared with existing work items but updates to the work item have not yet been compared with existing work items.

At step S406, a second dictionary of terms may be generated. A second dictionary of terms may, for example, include terms that are specific to the work item received at step S404. For example, the title of the work item may be stored in the second dictionary of terms. Items entered into the second dictionary may also simultaneously populate the first dictionary. In some implementations, population of the first dictionary with terms from the second dictionary may occur after population of the second dictionary. In some implementations, population of the first dictionary with terms from the second dictionary may occur in response to a triggering event such as a user instruction that population of the second dictionary is complete.

At step S408, the user may be requested to input additional terms. For example, if a user knows of terms that are specific to the work item, the user may input them into the system for inclusion in the second dictionary. A user may wish to add, for example, a dual language spellcheck option when creating a Chinese-to-English-to-Chinese translator. The user may add the terms “dual,” “language,” “spellcheck,” etc., to the second dictionary. In some embodiments, only a single dictionary may be used, and operations disclosed herein with respect to the second dictionary may be omitted or may be adapted for the single dictionary.

At step S410, the system may receive attributes of the work item from the user. Attributes may include primary attributes and secondary attributes. For example, primary attributes may include work item subject, work item description, a product tag, and/or theme assignments. Secondary attributes may include work item priority, backlog rank, work item age, creator ID, IDs of users in chatter relating to the work item, e.g., emails, text messages, etc. The primary attributes and the secondary attributes may be stored in a primary attribute table and in a secondary attribute table, respectively, or any other suitable storage mechanism. The attributes also may be used as inputs to a machine learning model as previously disclosed, which may weight the attributes based on the provided training data and any subsequent feedback received during operation of the system, as described in further detail below.

At step S412, a machine learning model may be created. The machine learning model may be an algorithm that the system will use to perform tasks based on patterns such as, for example, similarities between existing work items and a newly received work item. The machine learning model of the present implementations may be based on the first and second dictionary inputs above and “attributes” of a work item.

Completion of step S302 may result in a machine learning model, which may then be used to determine a similarity score in step S304. Step S304 is explained in more detail below.

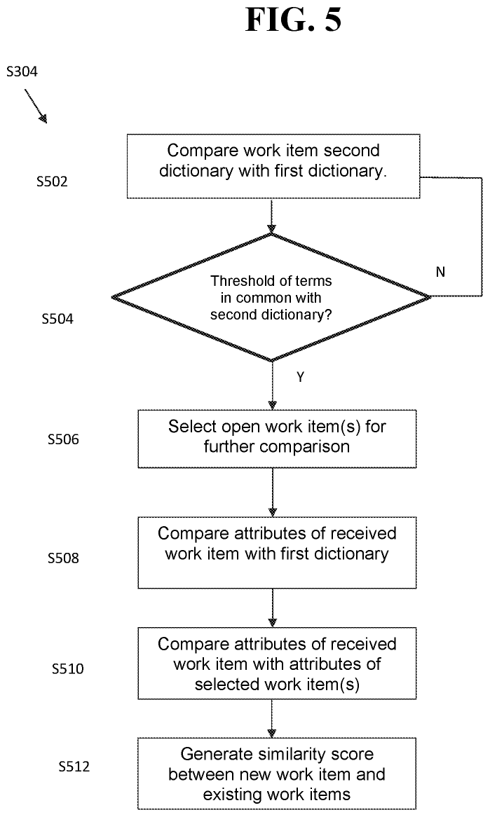

FIG. 5 shows an example process for step S304, generating a similarity score. Generating a similarity score may begin at step S502 by comparing the second dictionary of the received work item with the first dictionary. For example, whether an open work item, i.e., one that has not yet been completed, should be suggested as being related to a received work item or should be eliminated from consideration may first be based on determining how many matches exist between the first dictionary of all open items and the second dictionary of the received work item.

At step S504, the system may determine whether an open work item has terms in the first dictionary that reach a threshold level of “hits” resulting from the comparison with the second dictionary. At step S506, any open work items having the threshold level of hits may be selected for comparison with attributes of the received work item.

The system may, at step S508, conduct comparisons of the received work item's primary attributes and secondary attributes with the first dictionary. The comparisons may be made in parallel or the comparisons may be made in series with the received work item's second dictionary's comparison to the first dictionary of all open work items and with each other.

If comparisons are made in parallel, each of the received work item's second dictionary, primary attributes and secondary attributes are compared with the first dictionary at the same time. For example, upon reaching a threshold for selection in step S506, further comparison of the received item's second dictionary with the first dictionary of all open work items may continue; however, comparison of the primary attributes and secondary attributes may also begin. A total similarity score may be based on the number of similarities present between all of the first dictionary, the second dictionary, the primary attributes and the secondary attributes of the respective work items.

If comparisons of a received work item to an open work item are made in series, an order of comparisons may be previously programmed in the system or may be identified by the user. For example, the system may first complete comparison of the second dictionary of the received work item (step S502) with the first dictionary. After comparing the second dictionary of the received work item with the first dictionary of all open items, the system may then compare primary attributes of the received work item with the first dictionary of all open items. After comparing primary attributes of the received work item, the system may lastly compare the secondary attributes of the received work item with the first dictionary of all open items.

At step S510, a further comparison may be conducted between the selected open work items and the received work item. For example, primary attributes of a selected open item may be retrieved from the storage subsystem 106. Primary attributes of the received work item may be compared with the retrieved primary attributes of the selected open item.

The system may determine whether a second threshold is met before comparing additional attributes. For example, the system may compare primary attributes of the received work item only with primary attributes of the selected open work item and may only compare primary attributes of the received work item with secondary attributes of the selected open work item if a minimum (second) threshold is met.

A yet further comparison may be conducted between the selected open work items and the received work item. For example, secondary attributes of a selected open item may be retrieved from storage subsystem 106. Primary attributes of the received work item may be compared with the retrieved secondary attributes of the selected open item.

The system may determine whether a third threshold is met before comparing additional attributes. For example, the system may compare primary attributes of the received work item only with primary attributes and secondary attributes of the selected open work item and may only compare secondary attributes of the received work item with primary attributes of the selected open work item if a minimum (third) threshold is met.

A further comparison may be conducted between the selected open work items and the received work item. For example, primary attributes of a selected open item may be retrieved from storage subsystem 106. Secondary attributes of the received work item may be compared with the retrieved primary attributes of the selected open item.

The system may determine whether a fourth threshold is met before comparing additional attributes. For example, the system may compare primary attributes of the received work item with primary and secondary attributes of the selected open work item and may compare secondary attributes of the received work item with primary attributes of the selected open work item but may only compare secondary attributes of the received work item with secondary attributes of the selected open work item if a minimum (fourth) threshold is met.

A further comparison may be conducted between the selected open work items and the received work item. For example, secondary attributes of a selected open item may be retrieved from storage subsystem 106. Secondary attributes of the received work item may be compared with the retrieved secondary attributes of the selected open item.

The system may determine whether a fourth threshold is met before suggesting the selected open work item to a user. For example, the system may compare all attributes of the received work item with all attributes of the selected open but the attributes may not meet a final minimum threshold for suggestion to a user.

At step S512, a similarity score is generated based on the comparisons of step S502. A similarity score in a series and/or a parallel comparison may be based on a total number of similarities between dictionaries and attributes of the received work item and the selected open work item.

In some implementations, a similarity score may be based solely on a number of similarities in the first dictionary. For example, the system may determine how many entries of the first dictionary of the first work item are present in the second dictionary of the second work item and then provide a score based on the number of similarities present.

A similarity score may be based next on a number of similarities in the first dictionary and a number of similarities in the second dictionary. For example, in addition to determining a number of similarities at step S502, the system may then determine how many entries of the second dictionary of the received work item are present in the second dictionary of the open work item and then provide a score based on the number of similarities present.

In some implementations, the system may be programmed to conduct a comparison of all of the first dictionary, the second dictionary, the primary attributes and the secondary attributes in whatever order specified by the user. The system may also be programmed to compare less than all of the first dictionary, the second dictionary, the primary attributes and the secondary attributes of the received work item with the terms and attributes of the open work item.

It is not necessary that step S302 be complete before creating a similarity score. Steps S302 and S304 may be executed in series or in parallel. Parallel execution of steps S302 and S304 may be completely parallel, i.e., starting and stopping at the same time, or may be staggered parallel, i.e., overlapping execution with different starting and/or starting times.

For example, as terms of a received work item are entered into the second dictionary, the system may compare the second dictionary of the new work item, regardless of a status of population of the second dictionary, to a second dictionary of an existing work item. As primary attributes of a received work item are entered into the system, the system may compare the primary attributes of the received work item, regardless of a status of population of a primary attributes, to primary attributes of an existing work item. As secondary attributes of a received work item are entered into the system, the system may compare the secondary attributes of the received work item, regardless of a status of population of the secondary attributes, to secondary attributes of an existing work item.

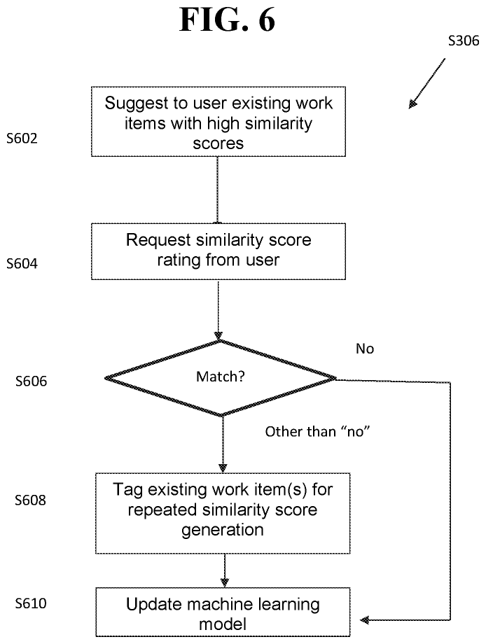

With reference to FIG. 6, after completing step S304, the system may proceed to step S306—applying and updating the machine learning model. Step S306 may begin at step S602, during which existing work items are suggested to a user to work on that that have high similarity scores, i.e., open work items that can easily be completed while working on a new (“received”) work item. For example, a user may select or be assigned a first work item to begin completing, such as where the user “checks out” a software bug report in a bug tracking system to analyze and correct within the software. At this point, the system may identify related work items as previously disclosed. Or, the stored similarity scores may be used to find one or more work items that are sufficiently similar that the system believes they can be addressed at the same time as the selected/assigned task.

At step S604, the system may ask a user to rate a proposed similarity. For example, the user may indicate that a suggested similarity is a perfect match; the user may indicate that the suggested similarity is an intermediate match; the user may indicate, at decision step S606, that the suggested similarity is not a match. As another example, the user may assign a numerical score indicating the degree of match between the suggested work item and the initial work item selected by the user.

If the user identifies the suggested work item as a perfect match, the suggested work item may be selected for immediate action with the new work item. For example, the suggested work item and the new work item may both be marked as assigned or checked out to the user, or otherwise noted as being assigned to the user for completion. The suggested work item may be opened concurrently with the new work item.

If the user identifies the suggested work item as no match, the suggested work item may be returned to the task-tracking system for completion in the usual course of operation. The system may tag the work item as a “no match” for the new work item in order to avoid future comparisons. In some implementations, the system may tag the work item as a suggested match, i.e., the system receives a response other than “no” and conducts a future comparison between the new work item and the suggested match. The suggested work item may also be compared to other work items that are suggested work items for the new work item to determine a work item pair to be addressed at a later time.

If the user identifies the suggested work item as an intermediate match, the suggested work item may be selected for follow-up action after the new work item is completed. For example, the suggested work item may be tagged for automatic assignment to the user upon completion of the new work item. The suggested work item may instead be tagged for automatic assignment to the user upon completion of an amount of progress of the new work item. Other techniques may be used. Furthermore the rating provided by the user may be used to improve future recommendations, such as where the recommended task(s), the new task, and the user's rating are provided to a machine learning model to further refine recommended tasks and/or the process used to select recommended tasks as disclosed in further detail herein.

At step S608, the suggested work item may be tagged for monitoring during completion of the new work item. For example, the suggested work item may be repeatedly compared with the new work item to determine continued confidence of the similarity score as the new work item is updated. If the similarity score drops to a pre-determined level, the user may be again asked whether the suggested work item remains a match with the new work item. The user may then decide that the suggested work item is no longer a match.

After the user determines whether the suggested work item is a perfect match, an intermediate match, or no match, the system may input the results from the user back into the system to reference with further work item comparisons. The machine learning model, at step S610, may be updated to base future comparisons on the particular similarity score that resulted in the present perfect match.

For example, the machine learning model may be updated to base future comparisons on similarity scores in which the perfect match resulted from a high correlation of similarities in the first dictionary, the second dictionary, the primary attributes, the secondary attributes, or any combination thereof. Similarly, the machine learning model may be updated to base future comparisons on the particular similarity score that resulted in the present “no match.” For example, the machine learning model may be updated to base future comparisons on similarity scores in which the “no match” resulted from a low correlation of similarities in the first dictionary, the second dictionary, the primary attributes, the secondary attributes, or any combination thereof. The machine learning model also may be updated to base future comparisons on the particular similarity score that resulted in the present “intermediate match.” For example, the machine learning model may be updated to base future comparisons on similarity scores in which the “intermediate match” resulted from a high correlation of similarities in the first dictionary and primary attributes but a low correlation of similarities in the second dictionary and secondary attributes, a high correlation of similarities in the second dictionary and secondary attributes but a low correlation of similarities in the first dictionary and primary attributes, or any combinations of similarities may be used to further train the machine learning model for intermediate matches.

The machine learning model, in intermediate matches, may be updated based on which combinations of similarities (first dictionary, primary attributes, etc.) are judged matches and which are declined as matches to determine a likelihood that combinations of similarities will likely be judged matches in the future.

The present disclosure relates to an adaptive method and system for grouping new and existing work items. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

As used herein, a given signal, event or value is “dependent on” a predecessor signal, event or value if the predecessor signal, event or value influenced the given signal, event or value. If there is an intervening processing element, step or time period, the given signal, event or value can still be “dependent on” the predecessor signal, event or value. If the intervening processing element or step combines more than one signal, event or value, the signal output of the processing element or step is considered “dependent on” to each of the signal, event or value inputs. If the given signal, event or value is the same as the predecessor signal, event or value, this is merely a degenerate case in which the given signal, event or value is still considered to be “dependent on” the predecessor signal, event or value. “Responsiveness” of a given signal, event or value upon another signal, event or value is defined similarly. As used herein, a “work item” or “task” refers to a discrete item to be completed within a larger project, such as development of a software application, design and/or fabrication of a complex device, or, more generally, any project that includes multiples components and/or to which multiple people or entities are expected to contribute. Unless specifically indicated

While the present disclosure is described with reference to implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

What is claimed is:

1. A method of identifying a task to be completed in a task-tracking system, the method comprising:
receiving, at a computerized task tracking system, a first task to be completed by a user, the first task describing a first change to be made within a computer system and having a first priority;
receiving, at the computerized task tracking system, a second task to be completed by a user, the second task describing a second change to be made within the computer system and having a second priority;
generating a similarity score indicating a similarity of the second task to the first task;
receiving an indication that a first user intends to complete the first task;
in response to receiving the indication that the first user intends to complete the first task, identifying one or more tasks in the task-tracking system that has a similarity score above a threshold, the one or more tasks including the second task; and
notifying the first user that the second task is similar to the first task.

2. The method of claim 1, further comprising:
receiving, from the first user, a rating indicating whether the second task was correctly identified as being similar to the first task.

3. The method of claim 2, further comprising:
updating a similarity score generation model in the computerized task-tracking system based upon the rating.

4. The method of claim 1, wherein the second priority is not higher than the first priority.

5. The method of claim 4, wherein the second priority is below a priority threshold set in the task-tracking system.

6. The method of claim 1, wherein the step of generating the similarity score further comprises:
applying a trained machine learning model to the first task and the second task, the machine learning model being configured to determine the similarity score based upon one or more attributes selected from the group consisting of: a task title, a task description, a product identifier, a task theme, a priority, a backlog rank, a task age, a task creator identifier, and a related user identifier.

7. The method of claim 6, further comprising training the machine learning model based on a vocabulary created for tasks in the computerized system.

8. The method of claim 6, further comprising:
receiving, from the first user, a rating indicating whether the second task was correctly identified as being similar to the first task.

9. The method of claim 8, further comprising:
updating the trained machine learning model based upon the rating.

10. The method of claim 1, wherein the step of generating the similarity score further comprises identifying a common category assigned to the first task and the second task within the task-tracking system.

11. A non-transitory computer readable medium having instructions that when performed on at least one processor cause the at least one processor to perform the steps comprising:
receiving, at a computerized task tracking system, a first task to be completed by a user, the first task describing a first change to be made within a computer system and having a first priority;
receiving, at the computerized task tracking system, a second task to be completed by a user, the second task describing a second change to be made within the computer system and having a second priority;
generating a similarity score indicating a similarity of the second task to the first task;
receiving an indication that a first user intends to complete the first task;
in response to receiving the indication that the first user intends to complete the first task, identifying one or more tasks in the task-tracking system that has a similarity score above a threshold, the one or more tasks including the second task; and
notifying the first user that the second task is similar to the first task.

12. The non-transitory computer readable medium of claim 11 having instructions causing the at least one processor to perform the steps, further comprising:
receiving, from the first user, a rating indicating whether the second task was correctly identified as being similar to the first task.

13. The non-transitory computer readable medium of claim 12 having instructions causing the at least one processor to perform the steps, further comprising: updating a similarity score generation model in the computerized task-tracking system based upon the rating.

14. The non-transitory computer readable medium of claim 11, wherein the second priority is not higher than the first priority.

15. The non-transitory computer readable medium of claim 4, wherein the second priority is below a priority threshold set in the task-tracking system.

16. The non-transitory computer readable medium of claim 1, wherein the step of generating the similarity score further comprises:
applying a trained machine learning model to the first task and the second task, the machine learning model being configured to determine the similarity score based upon one or more attributes selected from the group consisting of: a task title, a task description, a product identifier, a task theme, a priority, a backlog rank, a task age, a task creator identifier, and a related user identifier.

17. The non-transitory computer readable medium of claim 6 having instructions causing the at least one processor to perform the steps, further comprising:
training the machine learning model based on a vocabulary created for tasks in the computerized system.

18. The non-transitory computer readable medium of claim 6 having instructions causing the at least one processor to perform the steps, further comprising:
receiving, from the first user, a rating indicating whether the second task was correctly identified as being similar to the first task.

19. The non-transitory computer readable medium of claim 8 having instructions causing the at least one processor to perform the steps, further comprising:
updating the trained machine learning model based upon the rating.

20. The non-transitory computer readable medium of claim 1, wherein the step of generating the similarity score further comprises identifying a common category assigned to the first task and the second task within the task-tracking system.
